(19) United States
(12) Patent Application Publication
(10) Pub. No.: US 2014/0182463 A1
(43) Pub. Date: Jul. 3, 2014

(54) CUTTING DATA GENERATOR, CUTTING APPARATUS AND NON-TRANSITORY COMPUTER-READABLE MEDIUM STORING CUTTING DATA GENERATING PROGRAM

(71) Applicant: Yukiyoshi Muto, Nagoya-shi (JP)

(72) Inventor: Yukiyoshi Muto, Nagoya-shi (JP)

(73) Assignee: BROTHER KOGYO KABUSHIKI KAISHA, Nagoya-shi (JP)

(21) Appl. No.: 14/142,301

(22) Filed: Dec. 27, 2013

(30) Foreign Application Priority Data
Dec. 27, 2012 (JP) 2012-284946

(51) Int. Cl. B41J 11/66

(52) U.S. Cl. CPC B41J 11/663
USPC 101/3.1

(57) ABSTRACT

A cutting data generator includes a control device configured to obtain arrangement information including arrangement positions for arranging a plurality of types of decorative pieces with at least different colors and the types of the decorative pieces, to generate print data for printing identification marks at respective positions, based on the obtained arrangement information, the positions where the identification marks are to be printed corresponding to the arrangement positions respectively, the identification marks being indicative of the types of the decorative pieces respectively, and to generate cutting data for cutting a plurality of holes in a sheet material, based on the obtained arrangement information, the holes being usable to arrange the decorative pieces on the sheet material.

### CROSS-REFERENCE TO RELATED APPLICATIONS

This application is based upon and claims the benefit of priority from the prior Japanese Patent Application No. 2012-284946 filed on Dec. 27, 2012, the entire contents of which are incorporated herein by reference.

### BACKGROUND

1. Technical Field

The present disclosure relates to a cutting data generator generating cutting data for forming holes in a sheet using a cutting apparatus, in which holes decorative pieces are disposed, the cutting apparatus and a non-transitory computer-readable medium storing a cutting data generating program.

2. Related Art

Clothes and small goods have conventionally been decorated with decorative pieces “rhinestones.” The rhinestone has a rear surface provided with a hot-melt layer which is caused to adhere to clothes by an ultrasonic welding machine or a clothes iron thereby to be fixed. A rhinestone positioning sheet or a plate (a ruler) is used in the fixing work in order to desirably arrange the rhinestones. For example, the ruler has a number of holes in which the rhinestones are fitted respectively. The holes are arranged in a linear or curved shape. Furthermore, the holes are formed so as to be arranged into an outline of a pattern such as a square or heart or another shape. A user places the ruler on the clothes and fits rhinestones into the holes into a desired arrangement, positioning the rhinestones. The positioned rhinestones are caused to adhere to the clothes using an ultrasonic welding machine.

A number of colors of rhinestones such as red and blue are prepared and the rhinestones of favorite colors are arranged with the use of the rule, with the result that the user can enjoy colorful decoration.

However, when a decoration is made using a plurality of colors of rhinestones, the user is required to carry out a troublesome work of arranging the individual rhinestones in the respective holes of the ruler according to the colors. More specifically, the user repeatedly arranges and fixes rows of rhinestones one by one using the linearly arranged holes of the ruler when making a decoration with the rhinestones being arranged in rows and columns. In this case, the user is required to manually select the rhinestones one by one without mistaking the color while imaging an entire coloration. This requires a huge amount of effort when a number of rhinestones are used.

### SUMMARY

Therefore, an object of the disclosure is to provide a cutting data generator for making a sheet material, which can arrange a plurality of types of decorative pieces with different colors in an easy and accurate manner.

The present disclosure provides a cutting data generator including a control device configured to obtain arrangement information including arrangement positions for arranging a plurality of types of decorative pieces with at least different colors and said plurality of the types of the decorative pieces, to generate print data for printing identification marks at respective positions, based on the obtained arrangement information, the positions where the identification marks are to be printed corresponding to the arrangement positions respectively, the identification marks being indicative of the types of the decorative pieces respectively, and to generate cutting data for cutting a plurality of holes in a sheet material, based on the obtained arrangement information, the holes being usable to arrange the decorative pieces on the sheet material.

The disclosure also provides a non-transitory computer-readable storage medium storing computer-readable instructions that, when executed by a processor, cause the processor to perform the above-described steps.

The disclosure further provides a cutting apparatus including a printing instrument configured to print on a sheet material, a cutting instrument configured to cut the sheet material and a control device configured to execute the above-described steps.

### BRIEF DESCRIPTION OF THE DRAWINGS

In the accompanying drawings:

FIG. 1 is a perspective view of a cutting apparatus in accordance with a first example, showing an inner structure of the apparatus together with a body cover;

FIG. 2 is a plan view of the cutting apparatus, showing the inner structure thereof;

FIG. 3 is a longitudinal left side elevation taken along line III-III in FIG. 2;

FIG. 4 is a right side elevation of a cartridge holder and its periphery with a cartridge being attached;

FIGS. 5A and 5B are front views of a cutter cartridge and a pen cartridge respectively;

FIG. 6 is a block diagram showing an electrical arrangement of the cutting apparatus;

FIG. 7A is an enlarged plan view showing the relationship between a rhinestone and a hole;

FIG. 7B explains cutting data;

FIG. 8 explains arrangement information of rhinestones;

FIGS. 9A and 9B show an example of arrangement information of rhinestones and an example of specified color table defining color information with corresponding RGB values, respectively;

FIG. 10 is a conceptual diagram to explain storage areas of RAM;

FIG. 11 is a flowchart showing a sequence of processing executed on a cutting data generating program, print processing and cut processing;

FIGS. 12A to 12D show a procedure of making a sheet material for arrangement of rhinestones;

FIG. 13 shows arrangement information with the order having been changed by grouping color information;

FIG. 14 is a view similar to FIG. 6, showing a second example;

FIG. 15 is a view similar to FIG. 12D, showing a third example; and

FIG. 16 is a view similar to FIG. 12D, showing a fourth example.

### DETAILED DESCRIPTION

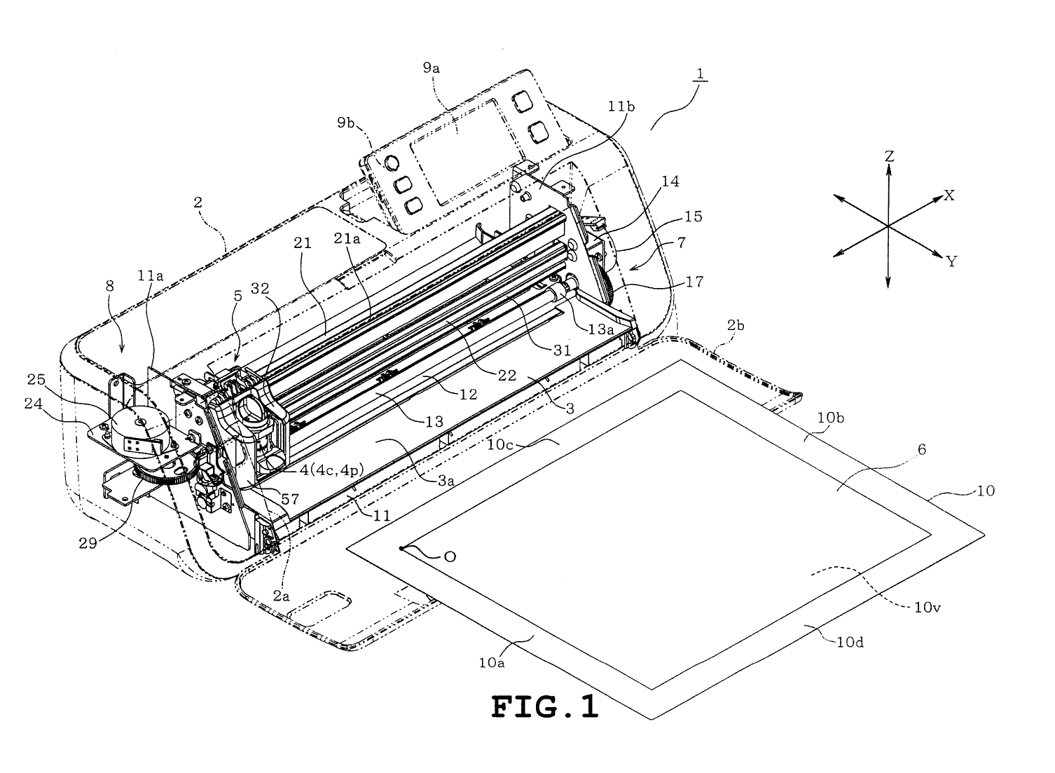

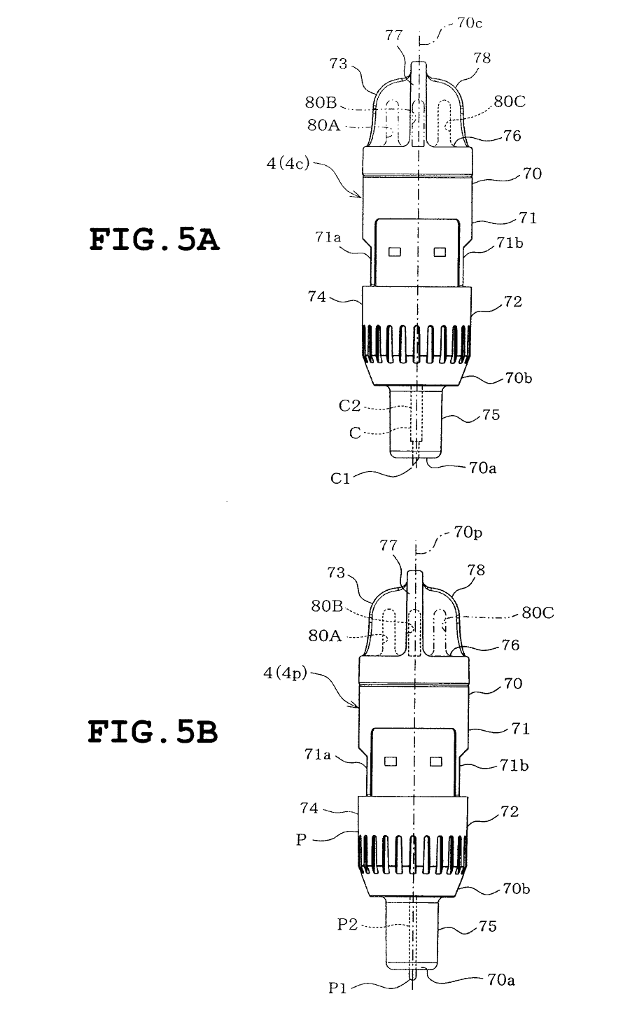

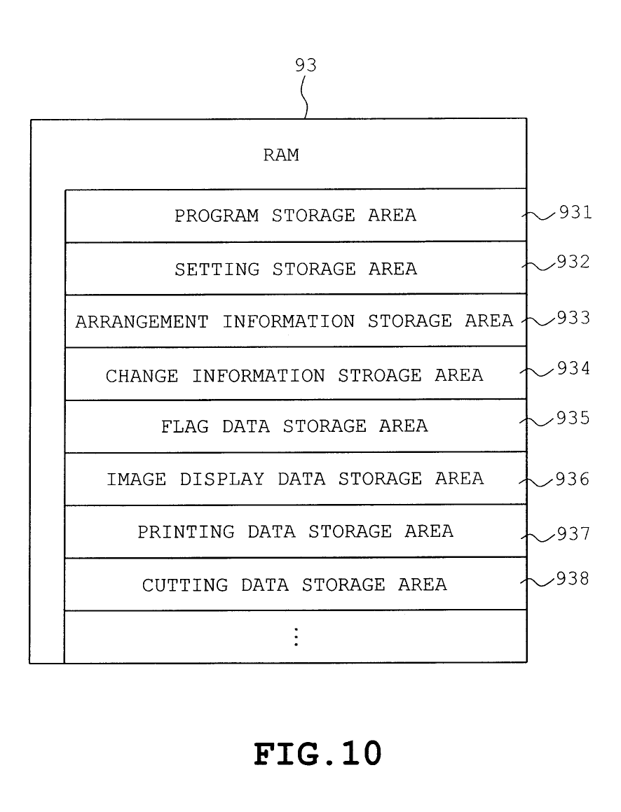

A first example will be described with reference to FIGS. 1 to 13 of the accompanying drawings. Referring to FIG. 1, a cutting apparatus 1 of the first example includes a body cover 2 serving as a housing, a platen 3 set up in the body cover 2 and a carriage on which is mounted a cartridge 4c of a cuter C or a cartridge 4p of a pen P (see FIGS. 5A and 5B).

The cutting apparatus 1 also includes a holding sheet 10 which holds an object 6 to be cut or to be printed. For example, the object 6 such as a resin sheet as a sheet material or paper, as shown in FIG. 1. A plurality of the cartridges 4c and a plurality of cartridges 4p are prepared as cutting instruments and printing instruments in the cutting apparatus 1 of the first example respectively. One of the cartridges 4c or one of the cartridges 4p is selectively attached to a cartridge holder 32 of the carriage 5 as will be described later. Since all the cartridges 4c and 4p include respective cases 70 which have substantially the same shape (see FIGS. 5A and 5B), the cartridges 4c and 4p are collectively referred to as “cartridge 4” for the purpose of illustration.

The body cover 2 is formed into a horizontally long rectangular box shape and includes a front formed with a front opening 2a and a front cover 2b mounted so as to openably close the front opening 2a. The holding sheet 10 holding the object 6 is set on the platen 3 or the cartridge 4 is attached to or detached from the cartridge holder 32.

The cutting apparatus 1 includes a transfer mechanism 7 which transfers the object 6 in a predetermined transfer direction (the Y direction). The cutting apparatus also includes a carriage moving mechanism 8 which moves the carriage 5 in a direction intersecting with the transfer direction of the object 6 (the X direction perpendicular to the transfer direction, for example). In the following description, the direction in which the object 6 is transferred by the transfer mechanism 7 will be referred to as “a front-rear direction.” More specifically, the front-rear direction is a Y-direction and a right-left direction perpendicular to the Y direction is the X direction.

A color liquid crystal display 9a (hereinafter, “display”) and an operations device 9b including a plurality of operation switches are mounted on a right upper surface of the body cover 2. The display 9a is capable of performing full color display. The display 9a is configured to serve as an informing equipment and a display unit which displays necessary messages and a pattern to be cut, a shape or the like. The operation device 9b is configured to be operated by the user to select a pattern displayed on the display 9a, to set various parameters, to instruct various functions, to input various conditions, and the like.

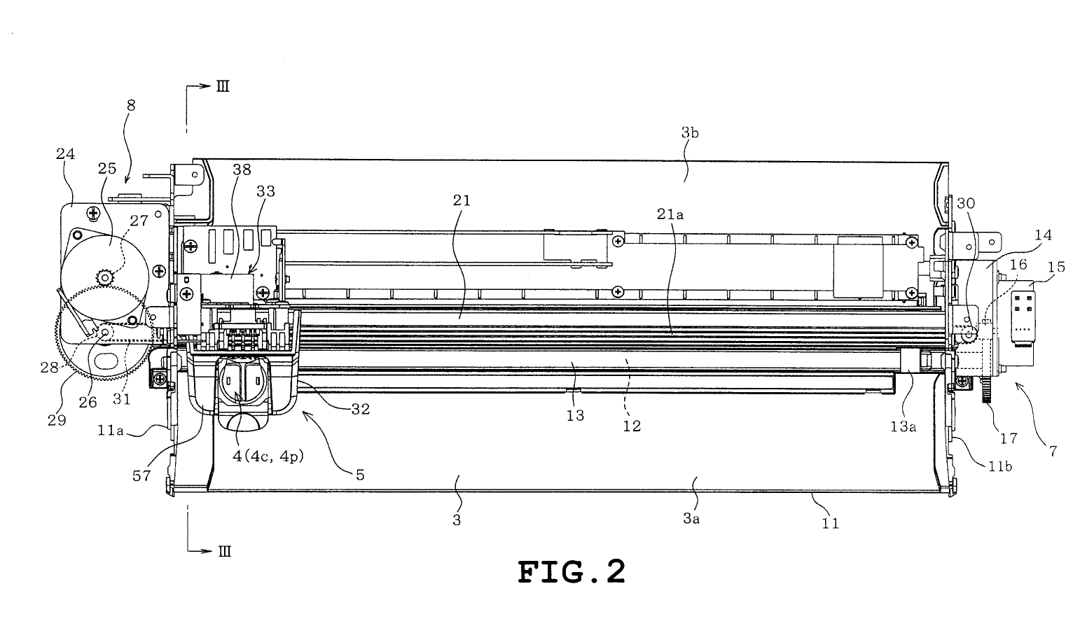

The platen 3 is adapted to receive the underside of the holding sheet 10 when the object 6 is cut. The platen 3 includes a front platen 3a and a rear platen 3b as shown in FIG. 2. The platen 3 has an upper surface which is substantially horizontal. The object 6 is transferred while the holding sheet 10 holding the object 6 is placed on the upper surface of the platen 3. The upper surface of the platen 3 has an adhesive layer 10v (see FIG. 1) formed by applying an adhesive agent to an inner area excluding peripheral ends 10a to 10d. The object 6 is affixed to the adhesive layer 10v thereby to be held by the holding sheet 10. The adhesive layer 10v has adhesive power set to a relatively smaller value so that the object 6 can easily be removed from the holding sheet 10. The transfer mechanism 7 and the carriage moving mechanism 8 serve as a relative movement unit which moves the holding sheet 10 holding the object 6 and the carriage 5 in the X and Y directions relative to each other.

The transfer mechanism 7 transfers the holding sheet 10 at the upper surface side of the platen 3 freely in the Y direction. More specifically, a frame 11 is enclosed in the body cover 2 as shown in FIGS. 1 and 2. The frame 11 includes right and left sidewalls 11b and 11a which are located at right and left sides of the platen 3 so as to face each other, respectively. A driving roller 12 and a pinch roller 13 are mounted on both sidewalls 11a and 11b so as to be located in a space between the front and rear platens 3a and 3b. The driving roller 12 and the pinch roller 13 extend in the X direction substantially in parallel to each other. The pinch roller 13 is located above the driving roller 12.

The driving roller 12 has an upper end which is substantially level with the upper surface of the platen 3 and right and left ends mounted on the right and left sidewalls 11b and 11a respectively so that the driving roller 12 is rotatable. The right end of the driving roller 12 extends rightward through the right sidewall 11b as shown in FIG. 2. A driven gear 17 having a large diameter is secured to a right distal end of the driving roller 12. A mounting frame 14 is fixed to an outer surface of the right sidewall 11b. A Y-axis motor 15 comprised of a stepping motor, for example is mounted on the mounting frame 14. The Y-axis motor 15 has an output shaft to which is fixed a driving gear 16 which has a small diameter and is to be brought into mesh engagement with the driven gear 17.

The pinch roller 13 has right and left ends mounted on the right and left sidewalls 11b and 11a respectively so that the pinch roller 13 is rotatable and slightly displaceable in the up-down direction. Two springs (not shown) are mounted on the outer surfaces of the right and left sidewalls 11b and 11a to normally bias the pinch roller 13 downward. Accordingly, the pinch roller 13 is normally biased downward (to the driving roller 12 side) by the springs. Two rollers 13a having a slightly large diameter are mounted on the pinch roller 13 so as to be located near both ends thereof respectively. Only the right roller 13a is shown in FIGS. 1 and 2.

The right and left ends 10b and 10a of the holding sheet 10 are thus held between the driving roller 12 and the rollers 13a of the pinch roller 13. Upon drive of the Y-axis motor 15, normal or reverse rotation of the Y-axis motor 15 is transmitted via the gears 16 and 17 to the driving roller 12, whereby the holding sheet 10 is transferred rearward or forward together with the object 6. The transfer mechanism 7 is thus constituted by the driving roller 12, the pinch roller 13, the Y-axis motor 15 and the gears 16 and 17 serving as a reduction mechanism.

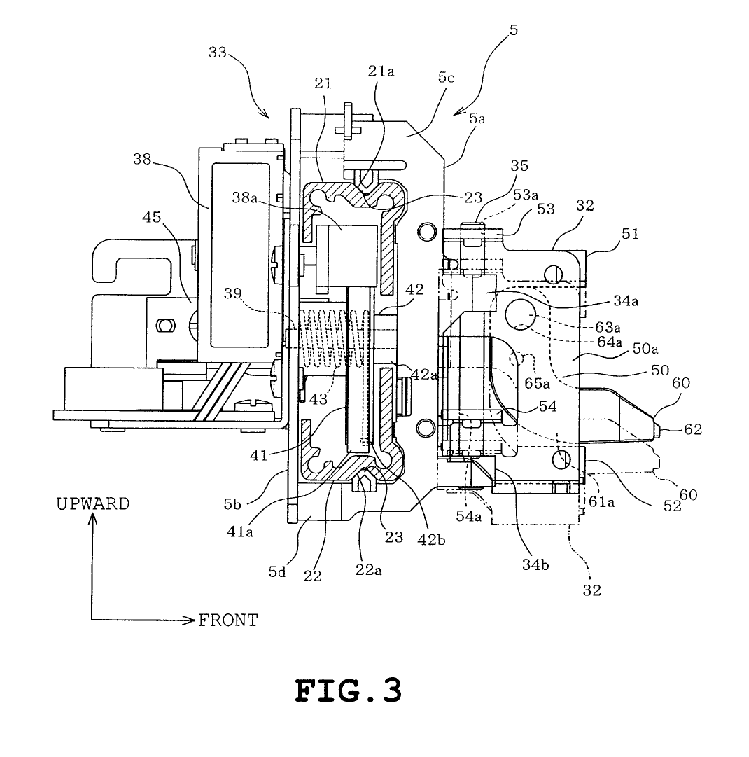

The carriage moving mechanism 8 serves to move the carriage 5 freely in the X direction. More specifically, as shown in FIGS. 1 and 2, a pair of guide rails 21 and 22 are fixed to the right and left sidewalls 11b and 11a so as to be located slightly rear above the pinch roller 13. The guide rails 21 and 22 extend in the right-left direction substantially in parallel to the pinch roller 13. Each of the guide rails 21 and 22 has a generally C-shaped section as viewed in the extending direction (the direction perpendicular to paper of FIG. 3). The upper guide rail 21 and the lower guide rail 22 are disposed to be symmetric with each other in the up-down direction so that both open faces are opposed to each other.

The upper guide rail 21 has an upper surface formed with a guide groove 21a extending from the left end to the right end thereof. The lower guide rail 22 has an underside also formed with a guide groove 22a (shown only in FIG. 3) extending from the left end to the right end thereof. Furthermore, the carriage 5 has upper and lower sides formed with protrusions 23 located in both guide grooves 21a and 22a respectively. The protrusions 23 extend in the right-left direction and engage the guide grooves 21a and 22a respectively. The carriage 5 is thus supported by the guide rails 21 and 22 so as to be slidable in the right-left direction.

A horizontal mounting frame 24 is fixed to the outer surface of the left sidewall 11a so as to be located near the rear of the cutting apparatus 1, as shown in FIGS. 1 and 2. An X-axis motor 25 is mounted on a rear part of the left mounting frame 24 to a downward direction. Furthermore, a vertically extending pulley shaft 26 (see FIG. 2) is mounted on the mounting frame 24 so as to be located in front of the X-axis motor 25. The X-axis motor 25 has an output shaft to which a driving gear 27 having a small diameter is fixed. A timing pulley 28 and a driven gear 29 having a large diameter are rotatably mounted on the pulley shaft 26. The driven gear 29 is brought into mesh engagement with the driving gear 27. The timing pulley 28 and the driven gear 29 are configured to be rotated together.

On the other hand, a timing pulley 30 is mounted on the right mounting frame 14 so as to be rotatable about an axis extending in the up-down direction. An endless timing belt 31 horizontally extends between the timing pulleys 30 and 28 in the right-left direction. The timing belt 31 has a midway part joined to a mounting part (not shown) of the carriage 5. The sidewalls 11a and 11b have through holes through which the timing belt 31 passes, respectively.

Upon drive of the X-axis motor 25, normal or reverse rotation of the X-axis motor 25 is transmitted via the gears 27 and 29 and the timing pulley 28 to the timing belt 31, whereby the carriage 5 is moved leftward or rightward. Thus, the carriage 5 is moved freely in the right-left direction perpendicular to the direction in which the object 6 is conveyed. The carriage moving mechanism 8 is thus constituted by the guide rails 21 and 22, the X-axis motor 25, the gears 27 and 29 serving as a reduction mechanism, the timing pulleys 28 and 30, the timing belt 31 and the like.

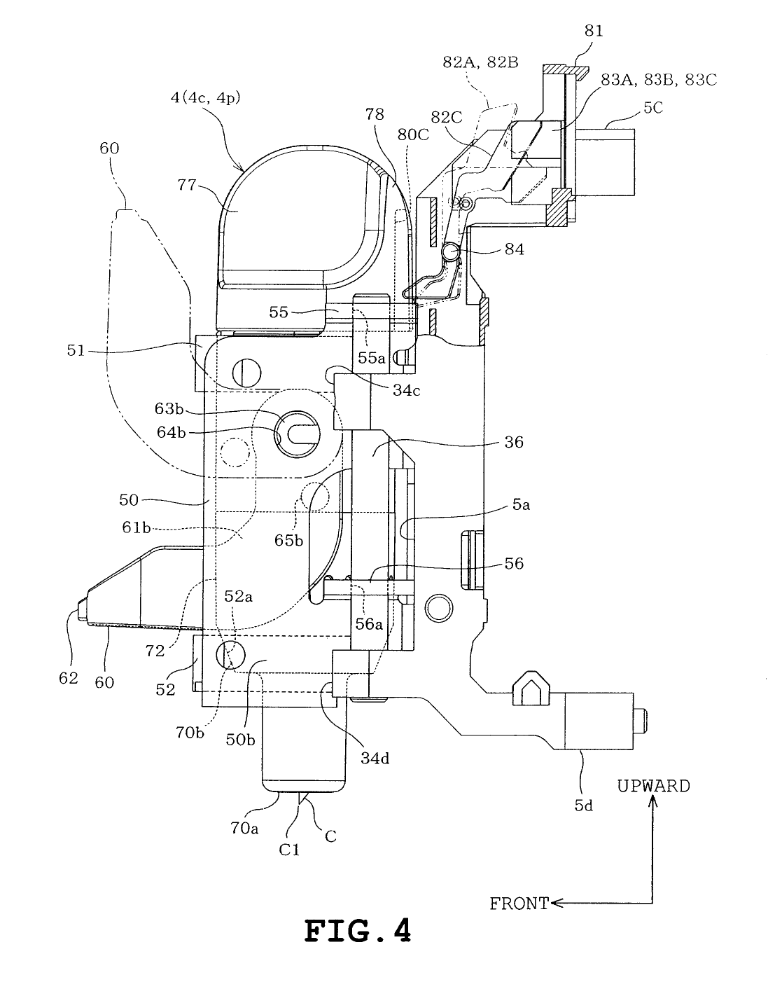

The carriage 5 includes an up-down drive mechanism 33 and a carriage holder 32 disposed back and forth as shown in FIGS. 2 and 3. The up-down drive mechanism 33 is configured to drive the cartridge holder 32 in the up-down direction (the Z direction) together with the cartridge 4. The carriage 5 includes front and rear walls 5a and 5b and upper and lower arms 5c and 5d connecting the walls 5a and 5b. Thus, the carriage 5 is shaped so as to surround the front and rear sides and upper and lower sides of the guide rails 21 and 22. A pair of up and lower supports 34a and 34b are mounted on a left end of the front wall 5a so as to protrude frontward. A round-bar like shaft 35 is fixed to the supports 34a and 34b so as to extend through the supports 34a and 34b in the up-down direction. Other supports 34c and 34d are also mounted on the right end of the front wall 5a as shown in FIG. 4. A shaft 36 is fixed to the supports 34c and 34d. The shafts 35 and 36 are inserted through both sides (holes 53a, 54a, 55a and 56a of support pieces 53 to 56 as will be described later; and see FIGS. 3 and 4) of the cartridge holder 32, whereby the cartridge holder 32 is supported so as to be movable in the up-down direction.

The protrusion 23 engaging the guide groove 21a is provided on the upper arm 5c of the carriage 5 as shown in FIG. 3. The protrusion 23 engaging the guide groove 22a of the guide rail 22 is provided on the lower arm 5d. A Z-axis motor 38 is mounted on a slightly upper part of the rear wall 5b of the carriage 5 so as to be directed forward. The Z-axis motor 38 is comprised of a stepping motor, for example and has an output shaft to which a driving gear 38a having a small diameter is fixed. A gear shaft 39 extending frontward is mounted on the rear wall 5b of the carriage 5 so as to be located in the right-bottom side of the Z-axis motor 38. A driven gear member 41 and a pinion gear member 42 are rotatably supported on the gear shaft 39.

The driven gear member 41 has a small diameter portion and a large diameter portion both formed integrally therewith. A gear 41a to be brought into mesh engagement with the driving gear 38a is formed on the large diameter portion. The driven gear member 41 has an enclosure formed therein and having a front opening. A torsion coil spring 43 is enclosed in the enclosure as will be described late. The pinion gear 42 has a flange 42b and a small-diameter portion both formed integrally therewith. The flange 42b covers the enclosure of the driven gear member 41 from the front. A gear 42a is formed on the small-diameter portion of the pinion gear member 42. The torsion coil spring 43 as shown in FIG. 3 is enclosed in the enclosure of the driven gear member 41. The torsion coil spring 43 has one end locked at the driven gear member 41 side and the other end locked at the pinion gear member 42 side. A rack (not shown) formed integrally on the cartridge holder 32 is brought into mesh engagement with the gear 42a of the pinion gear member 42.

Upon drive of the Z-axis motor 38, normal or reverse rotation of the Z-axis motor 38 is transmitted via the driving gear 38a, the driven gear member 41, the torsion coil spring 43 and the pinion gear member 42 to the rack, whereby the cartridge holder 32 is moved upward or downward together with the cartridge 4. As a result, the cartridge holder 32 (the cartridge 4) moved between a lowered position (see alternate long and two short dashes line in FIG. 3) and a raised position. When the cartridge holder 32 is located at the lowered position, the cutting by the cutter C or the printing by the pen P is executed (see the alternate long and two short dashes line in FIG. 3). When the cartridge holder 32 is located at the raised position, the blade edge C1 or the pen tip P1 (see FIGS. 5A and 5B) is spaced away from the object 6 by a predetermined distance.

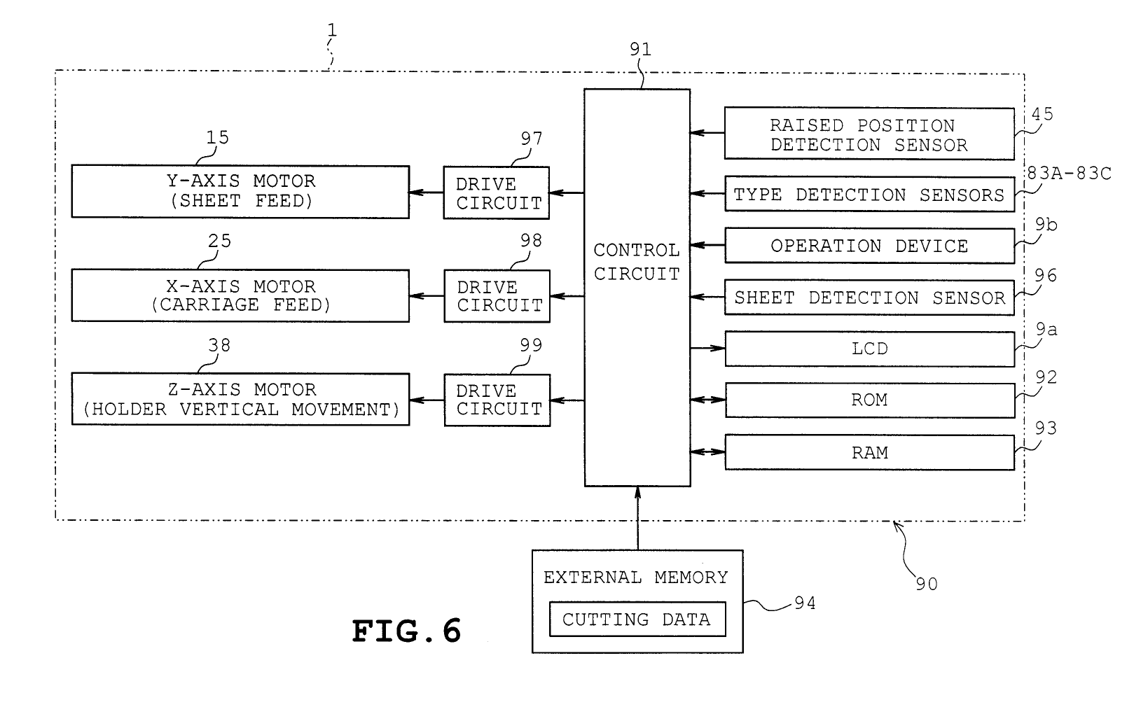

A raised position detection sensor 45 is provided on a rear wall 5b of the carriage 5 to detect the raised position of the cartridge holder 32 although not shown in detail (see FIGS. 3 and 6). The raised position detection sensor 45 is an optical sensor and is comprised of a photointerrupter detecting a rotation position of a shutter piece (not shown) which is provided to be rotated with the driven gear member 41. As a result, the raised position of the cartridge holder 32 to which the cartridge 4 is attached is defined on the basis of a detection signal of the sensor 45. The up-down drive mechanism 33 is constituted by the Z-axis motor 38, the gear members 38a, 41 and 42 serving as the reduction mechanism, the torsion coil spring 43, the rack and the like.

Pressures of the blade edge C1 of the cutter C and the pen tip P1 are set to predetermined values suitable for cutting and printing of the object 6, based on an amount of rotation of the Z-axis motor 38. The following will exemplify the case where the pressure of the blade edge C1 is set. When the Z-axis motor 38 is rotated clockwise as viewed at the front, the driven gear 41 is rotated counterclockwise. The counterclockwise rotation of the driven gear 41 is transmitted via the pinion gear member 42, which is rotated counterclockwise with the result that the gear 42a moves the rack of the cartridge holder 32 downward. Thus, the cartridge holder 32 and that is, the cartridge 4c are moved downward from the raised position. When the blade edge C1 of the cutter C and the underside 70a (see FIG. 4) of the cartridge 4c are pressed against the object 6, further downward movement of the cartridge 4c cannot be allowed. In this case, the pinion gear member 42 cannot be rotated further and is stopped. However, when the Z-axis motor 38 is thereafter kept rotating, only the driven gear member 41 is rotated, whereby the torsion coil spring 43 is flexed in a winding direction. The cutting pressure of the blade edge C1 (hereinafter, “cutter pressure”) is thus set to a biasing force proportional to a deflection angle of the torsion coil spring 43.

In the case of the cartridge 4p of the pen P, the Z-axis motor 38 is further rotated when the cartridge holder 32 is located at the lowered position where the pen tip 21 abuts against the object 6, whereby the pressure of the pen tip P1 (hereinafter, “pen pressure”) is set to a biasing force proportional to the deflection angle of the torsion coil spring 43. As described above, the cutter pressure and the pen pressure are set to pressures suitable for cutting and printing via the torsion coil spring 43 based on an amount of rotation of the Z-axis motor 38, respectively.

On the other hand, when the Z-axis motor 38 is rotated counterclockwise as viewed at the front, the driven gear 41 is rotated clockwise. When the driven gear 41 is rotated clockwise, the driven gear 41 directly presses the pinion gear member 42 thereby to rotate the pinion gear member 42 clockwise although a rotating mechanism in this case is not shown in detail. More specifically, the torsion coil spring 43 does not work when the driven gear member 41 is rotated clockwise. The gear 42a moves the rack upward when the pinion gear member 42 is rotated clockwise. As a result, the cartridge holder 32 and accordingly the cartridge 4 are moved upward from the lowered position.

The cartridge holder 32 includes a holder frame 50 provided with the rack and upper and lower holders 51 and 52 both fixed to the holder frame 50, as shown in FIGS. 3 and 4. The holder frame 50 has a top, underside and front all of which are open. The holder frame 50 has a left wall 50a on which a pair of upper and lower support pieces 53 and 54 are provided so as to protrude outward as shown in FIG. 3. The holder frame 50 also has a right wall 50b on which a pair of upper and lower support pieces 55 and 56 are provided so as to protrude outward as shown in FIG. 4. The support pieces 53 to 56 are formed with through holes 53a, 54a, 55a and 56a respectively.

The shaft 35 of the carriage 5 is inserted through the holes 53a and 54a of the left support pieces 53 and 54 and the shaft 36 of the carriage 5 is inserted through the holes 55a and 56a of the right support pieces 55 and 56, respectively. As a result, the holder frame 50 is supported to be movable in the up-down direction along the shafts 35 and 36. The carriage 5 is provided with a cover member 57 (see FIGS. 1 and 2) which covers the support pieces 53 to 56 of the holder frame 50 and the shafts 35 and 36. The cover member 57 has a central part formed with an opening through which the upper and lower holders 51 and 52 and an inner wall of the holder frame 50 are exposed.

The upper and lower holders 51 and 52 are attached so that the cartridge 4 is insertable through the holders 51 and 52. Each holder is formed into a frame shape so as to be fitted in the holder frame 50. Each of the holders 51 and 52 has an inner diameter set so that each holder is fitted with the outer periphery of the cartridge 4 to be attached. The lower holder 52 has a tapered portion 52a (see FIG. 4) which abuts against a tapered portion 70b of the cartridge 4 thereby to prevent downward movement of the cartridge 4.

The holder frame 50 is provided with a lever member 60 serving as a pressing unit which presses the cartridge 4. The lever member 60 has a pair of right and left arms 61a and 61b and an operating portion 62 provided so as to connect between distal end sides of the arms 61a and 61b as shown in FIGS. 3 and 4. The arms 61a and 61b are each formed into a plate shape and are disposed to sandwich both sides of the cartridge 4. Furthermore, the lever member 60 has a proximal end formed with small cylindrical pivot shafts 63a and 63b located at outer surface sides of the arms 61a and 61b respectively. The pivot shafts 63a and 63b are inserted through circular holes 64a and 64b formed in the walls 50a and 50b of the holder frame 50 respectively. As a result, the lever member 60 is swung about the pivot shafts 63a and 63b serving as a center of swinging motion so as to be switchable between an open position shown by alternate long and two short dashes line in FIG. 4 and a fixed position show by solid line in FIG. 4.

The arms 61a and 61b further have inner surfaces formed with small cylindrical engagement portions 65a and 65b located near the pivot shafts 63a and 63b respectively. The engagement portions 65a and 65b are disposed so as to engage an upper end of a cap 72 of the cartridge 4 from above when the lever member 60 is located at the fixed position, as will be described later. As the result of engagement of the engagement portions 65a and 65b and the cap 72, the cartridge 4 is fixed while in abutment with the tapered portion 52a of the lower holder 52 (see FIG. 4). On the other hand, with swing of the lever member 60 from the fixed position to the open position side, the engagement portions 65a and 65b depart from the cap 72, whereby the cap 72 is released from the fixed state. The lever member 60 thus presses the cartridge 4 by the engagement portions 65a and 65b thereby to releasably fix the cartridge 4.

The cartridges 4c and 4p of the respective cutter C and pen P as exemplified in FIGS. 5A and 5B will now be described with respect to the cartridge 4 attached to and detached from the cartridge holder 32. The cartridge 4c of the cutter C and the cartridge 4p of the pen P include the same case 70 and are selectively attached to the cartridge holder 32. More specifically, the case 70 includes a case body 71 and the cap 72 and a knob 73 provided on one end and the other end of the body 71 respectively. The case body 71 is formed into a cylindrical shape and extends in the up-down direction. The case body 71 has right and left sides provided with escape portions located midway in the up-down direction. The escape portions 71a and 71b are each formed into a concave shape in order to escape contact with the engagement portions 65a and 65b of the lever member 60.

The cap 72 includes a larger-diameter portion 74 fitted with the case body 71 and a smaller-diameter portion 75 and is accordingly formed into the shape of a stepped bottomed cylindrical container. The larger-diameter portion 74 includes a frustoconical or tapered portion 70b which is formed over an entire circumference thereof and is in abutment with a tapered portion 52a of the cartridge holder 32. The tapered portion 70b of the larger-diameter portion 74 is set to the same inclination angle as the tapered portion 52a of the cartridge holder 32. An upper end of the larger-diameter portion 74 or the peripheral end of the cap 72 is pressed by the engagement portions 65a and 65b of the lever member 60. The underside 70a of the cap 72 is formed into a flat shape and has a hole (not shown) through which the blade edge C1 of the cutter C or the pen tip P1 passes.

The knob 73 has a cover plate 76 fixed to an upper surface of the case body 71, a knob plate 77 and a rear plate 78 both formed on an upper side of the cover plate 77. The plates 76, 77 and 78 are formed integrally with the knob 73. The knob plate 77 is mounted on a central part of the cover plate 76 in the right-left direction so as to be directed vertically.

The cartridge 4c shown in FIG. 5A includes a cutter C serving as a cutting instrument. The cutter C serving as a cutting blade has a proximal end or a round bar shaped cutter shaft C2 enclosed in the case 70 and a distal end (a lower end) or the blade edge C1. The blade edge C1 and the cutter shaft C2 are formed integrally with the cutter C. The blade of the cutter C is formed into a substantially triangular shape tilted relative to the object 6 although not shown in detail in the drawings.

Bearings are provided in the case body 71 to support the cutter shaft C2 so that the cutter shaft C2 is rotatable about a central axis 70c thereof, although not shown in the drawings. The blade edge C1 protrudes from the underside 70a of the cap 72. The tapered portion 70b of the cap 72 is concentric with the cutter shaft C2 or has a central axis corresponding with the central axis 70c of the cutter shaft C2.

The cartridge 4c shown in FIG. 5B is a printing instrument formed into the pen P and has a distal end or the pen tip P1 from which ink is caused to seep. An ink tank (not shown) is provided in the case body 71 to supply ink to a pen tip member P2. The pen tip P1 protrudes from the underside 70a of the cap 72. The tapered portion 70b of the cap 72 is concentric with the pen tip member P2 or has a central axis corresponding with a central axis 70p of the pen tip member P2.

Any one of three grooves 80A to 80C is formed in the rear plate 78 of the knob 73 as shown in FIGS. 4, 5A and 5B. The grooves 80A to 80C serve as identification portions for identifying a type of the cartridge 4. The grooves 80A to 80C have different concavo-convex patterns according to types of the cartridges 4 and types of colors of the pens P. More specifically, for example, the cutting cartridge 4c or the printing cartridge 4p can be identified based on presence or absence of the groove 80C at the right end of the rear plate 78, as shown in FIGS. 5A and 5B. Furthermore, for example, the type of pen P color can be identified based on presence or absence of the grooves 80A and 80B of cartridge 4p. The identification portions may have any configuration which can identify the type of the cartridge 4, for example, the number of grooves may be changed according to the type of pen P color.

The cartridge holder 32 of the carriage 5 is provided with a detection unit which identifies the type of the cartridge 4. The detection unit includes three contacts 82A to 82C mounted on a substrate holder 81 and three type detection sensors 83A to 83C mounted on a substrate of the substrate holder 81. More specifically, the substrate holder 81 is provided on an upper rear of the holder frame 50. The type detection sensors 83A to 83C are arranged in the right-left direction on the substrate holder 81 so as to correspond to the grooves 80A to 80C respectively. The type detection sensors 83A to 83C are optical sensors serving as detectors and comprise photointerrupters respectively.

The contacts 82A to 82C are formed into the shapes of plates extending from the rear plate 78 side of the knob 73 to the side of the type detection sensors 83A to 83C. The contacts 82A to 82C have shaft portions 84 formed midway in the lengthwise direction, respectively, as shown in FIG. 4. The substrate holder 81 is provided with bearings (not shown) supporting the shafts 84 so that the contacts 82A to 82C arranged in the thicknesswise direction are swingable. Three extension coil springs (not shown) are provided between raised portions of contacts 82A to 82C and the substrate holder 81 respectively. The contacts 82A to 82C are biased by the extension coil springs in a direction such that upper ends of the contacts 82A to 82C are tilted to the side of the type detection sensors 83A to 83C, that is, such that lower ends of the contacts 82A to 82C contact with the rear plate 78 of the knob 73.

For example, when the cartridge 4c of the cutter C has been attached to the cartridge holder 32, the lower ends of the contacts 82A and 82B contact with the rear plate 78 thereby to be swung. With this, the upper ends of contacts 82A and 82B depart from the type detection sensors 83A and 83B (see alternate long and two short dashes line in FIG. 4). On the other hand, the other contact 82C is retained in the tilted position such that the lower end thereof fits into groove 80C side and the upper end thereof fits into the type detection sensor 83C side.

In cutting the object 6, a control circuit 91 (see FIG. 6), which will be described in detail later, controls the cartridge 4c attached to the cartridge holder 32 based on detection signals the contacts 82A to 82C, so that the cartridge 4c is moved to the lowered position by the up-down drive mechanism 33 to be set to the aforesaid cutter pressure. In this case, the blade edge C1 is thrust through the object 6 on the holding sheet 10 slightly into the holding sheet 10. In this state, the holding sheet 10 and the cartridge 4c (the cutter C9) are moved in the X and Y directions relative to each other, whereby a cutting operation for the object 6 is executed.

On the other hand, when the cartridge 4p of the pen P is attached to the cartridge holder 32, the control circuit 91 controls the pen tip P1 based on the detection signals of the contacts 82A to 82C, so that the pen tip P1 abuts against the object 6 with the cartridge 4p being located at the lowered position. In this state, the holding sheet 10 and the cartridge 4p (the pen P) are moved in the X and Y directions relative to each other by the transfer mechanism 7 and the carriage moving mechanism 8, whereby a printing operation for the object 6 is executed. An X-Y coordinate system is set in the cutting apparatus 1, for example. The X-Y coordinate system has an origin O that is a left corner of the adhesive layer 10v of the holding sheet 10 as shown in FIG. 1, and the holding sheet 10 (the object 10) and the cutter C or the pen P are moved relative to each other based on the X-Y coordinate system.

The configuration of the control system of the cutting apparatus 1 will be described with reference to FIG. 6. The control circuit (a control device) 91 controlling an entire cutting apparatus 1 is composed of a computer (a CPU) as a main component. A ROM 92, a RAM 93 and an external memory 94 are connected to the control circuit 91.

The ROM 92 stores a cutting control program for controlling a cutting operation, a printing control program for controlling a printing operation and a display control program for controlling a displaying operation of the display 9a. The ROM stores a cutting data generation program which will be described later, an operation information table and the like. The operation information table includes detection information supplied from the type detection sensors 83A to 83C and operation information corresponding to the detection information. The operation information includes cutter pressure and pen pressure both set for every type of the cartridge 4 and a relative movement speed (speed data of the Y-axis motor 15 and the X-axis motor 25). The external memory 94 stores cutting data for cutting a plurality of types of patterns.

To the control circuit 91 are supplied a signal from a sheet detection sensor 96 detecting a distal end of the holding sheet 10, a signal from a raised position detection sensor 45, the signals from the type detection sensors 83A to 83C, and the like. The display 9a and the operation device 9b are also connected to the control circuit 91. While viewing the display contents of the display 9a, a user operates one or more switches of the operation device 9b, whereby the user can set arrangement information which will be described later and various parameters. To the control circuit 91 are further connected drive circuits 97, 98 and 99 driving the Y-axis motor 15, the X-axis motor 25 and the Z-axis motor 38 respectively. The control circuit 91 controls the motors 15, 25 and 38 and the like based on the cutting or printing data, so that a cutting or printing operation for the object 6 on the holding sheet 10 is automatically executed.

In the example, the cutting data generation program is executed to generate cutting and printing data for making a sheet material defining an arrangement of granular decorative pieces. Rhinestones 100 which are one type of artificial gems made of glass or plastic, for example. The rhinestones 100 are substantially circular in shape and have various colors including red, blue, green, rose and emerald green. Facet cutting is applied to the surface of the rhinestone 100. The rhinestone 100 has a reverse side which is formed into a flat side and has a hot melt layer. Accordingly, the rhinestone 100 can be bonded and fixed to clothes or the like by heat of a clothes iron, for example.

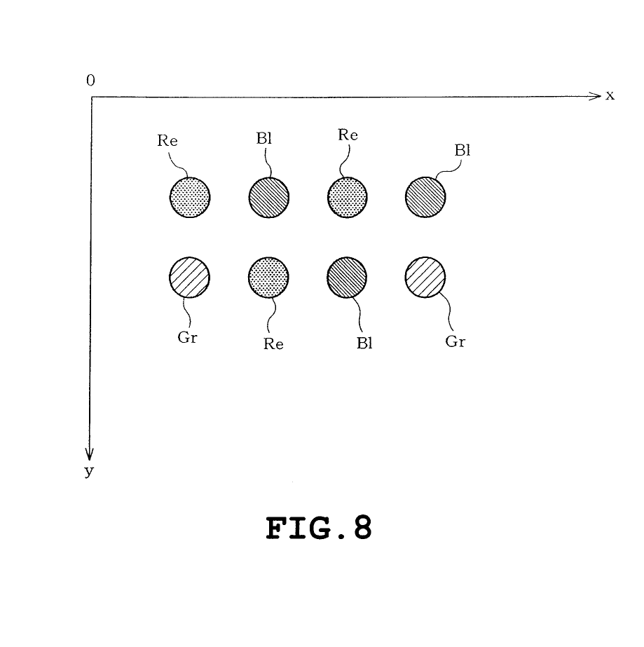

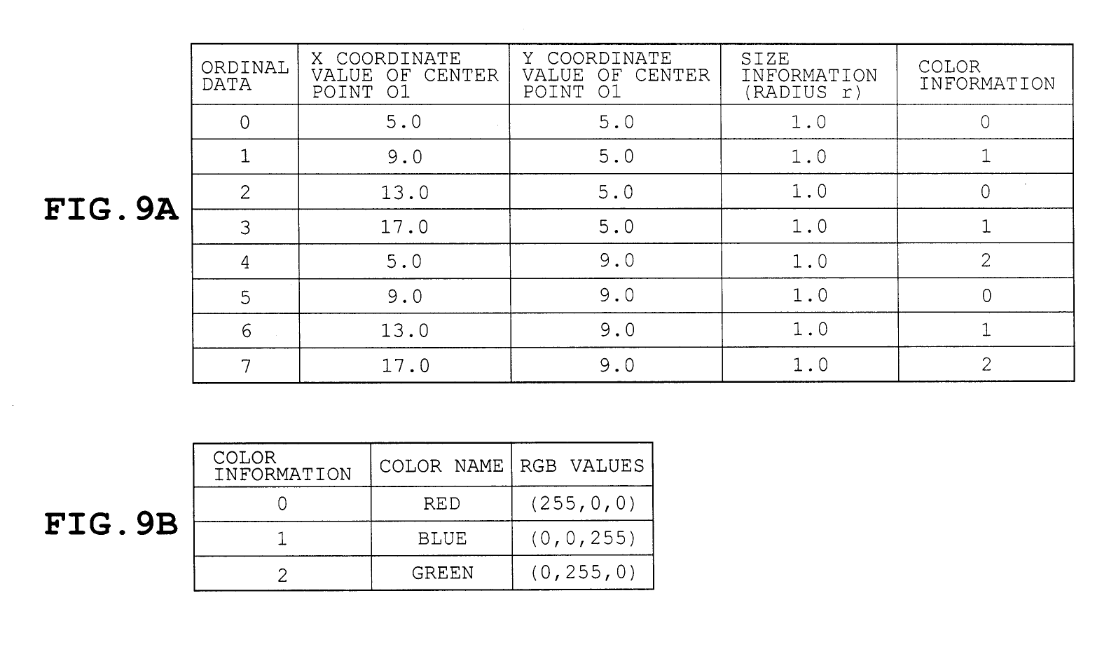

The above-mentioned cutting data generation program may include arrangement information of typical rhinestones 100 and defaults as will be described later. Furthermore, the control circuit 91 and the operation device 9b are configured as an arrangement information obtaining unit, and the user can optionally set the arrangement information. Circles as shown in FIG. 8 exemplify an arrangement of the rhinestones 100. Symbols Re, Bl and Gr designate red, blue and green which are types of colors of the rhinestones 100, respectively. FIG. 9A shows arrangement information of the rhinestones 100.

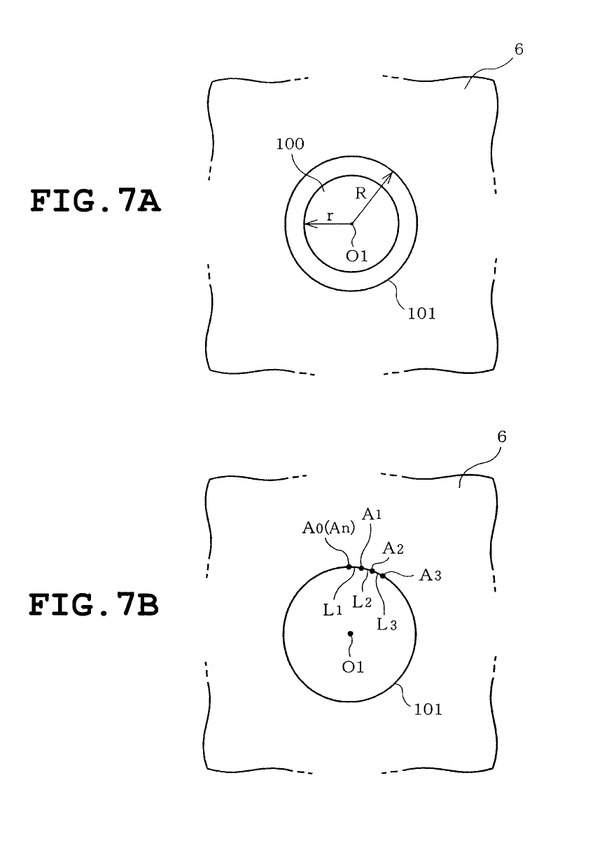

The arrangement information of the rhinestones 100 includes ordinal data to specify an arrangement order, arrangement position represented by X-Y coordinate, size information representing types of the rhinestones 100 and color information. More specifically, both “5.0” and “5.0” corresponding to top ordinal data “0” in FIG. 9A indicate X coordinate value and Y coordinate value of a center point O1 (see FIG. 7A) of the upper left end rhinestone 100 in FIG. 8. Size information “1.0” indicates the value of radius (in mm) of the rhinestone 10. Color information “0” corresponds to RGB values “255, 0, 0” of red as shown in FIG. 9B.

The color information is thus specified as numeric values “0,” “1,” “2,” . . . in the cutting data generation program and defined as a specific color table inclusive of colors of the rhinestones 100 and RGB values specifying the colors of the rhinestones 100. In the same manner, arrangement information of the other seven rhinestones 100 includes ordinal data “1” to “7,” arrangement position “9.0, 5.0” to “17.0, 9.0,” size information “1.0” to “1.0” and color information “1” and “2.”

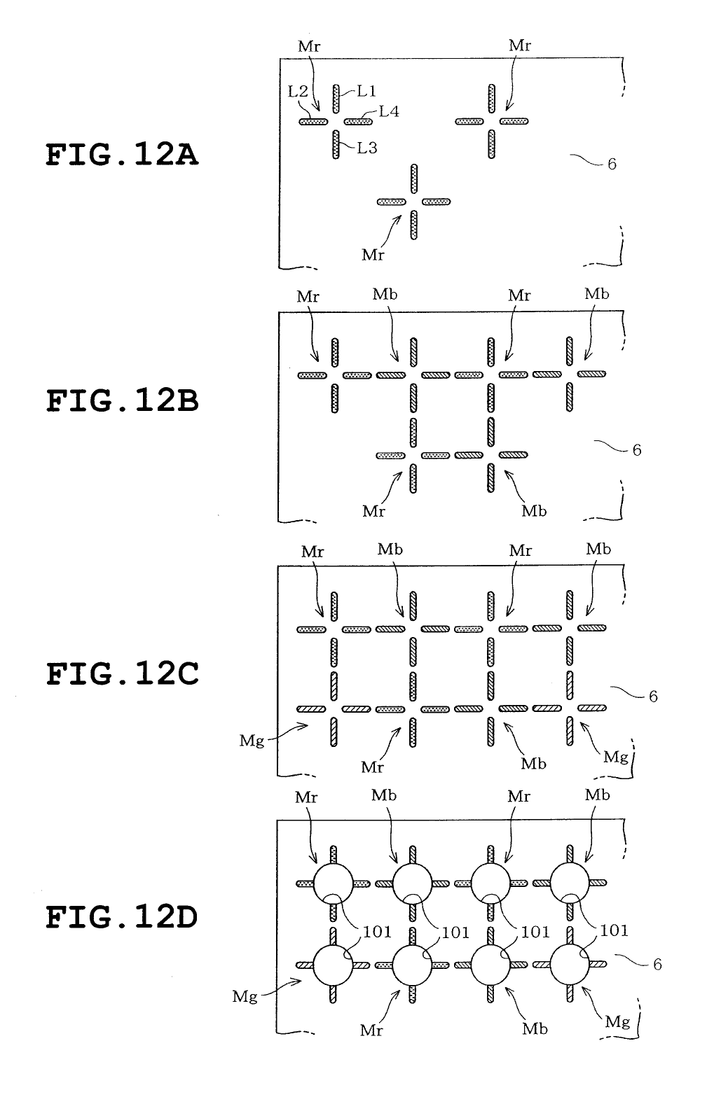

The following will describe a case where a sheet material is made by cutting eight holes 101 from a plastic sheet serving as the object 6 regarding the cutting data. As shown in FIGS. 7A and 12D, eight circular holes 101 are to be cut from the object 6. Each hole 101 has a size such that the rhinestone 100 is fitted thereinto. The cutting data in this case includes cutting line data, delimited data and display data. The cutting line data includes X-Y coordinate value data indicating apexes of cutting line composed of a plurality of line segments and specified by the X-Y coordinate system of the cutting apparatus 1.

More specifically, a cutting line of the hole 101 includes line segments L1, L2, L3, and so on connecting cutting start points A₀, apex A₁, apex A₂, . . . , and cutting end point Aₙ on the circumference, as shown in FIG. 7B. The cutting line is formed substantially into a circular shape as a whole by setting interapex distances to a small value, and the cutting start point A₀ corresponds with the cutting end point Aₙ. The cutting line data has first coordinate data, second coordinate data, third coordinate data, . . . and (n+1)-th coordinate data corresponding to cutting start points A₀, apex A₁, apex A₂, . . . , and cutting end point Aₙ respectively.

The control circuit 91 serving as the cutting control unit controls the cutting apparatus 1 to execute a cutting operation in which the holes are cut sequentially from the hole 101 of ordinal data of “0.” More specifically, firstly, the cutter C is relatively moved to the X-Y coordinate of cutting start point A₀ by the transfer mechanism 7 and the carriage moving mechanism 8. Next, the blade edge C1 of the cutter C is caused to pass through the cutting start point A₀ of the object 6 by the up-down drive mechanism 33, and the blade edge C1 is relatively moved by the transfer mechanism 7 and the carriage moving mechanism 8 so that apexes A₁, A₂, A₃ and so on are sequentially connected by straight lines. Thus, when the line segments L1, L2 and L3 and so on are cut continuously, the cutting line of the circular hole 101 is cut.

The other seven holes 101 are also cut in the order of ordinal data “1” to “7” based on the respective cutting line data in the same manner as described above. Delimiter data are suffixed to the ends of the eight line data respectively. The blade edge C1 of the cutter C is departed from the object 6 by the up-down drive mechanism 33 on the basis of the delimiter data every time the cutting of each cutting line ends.

The control circuit 91 is configured to generate the aforementioned cutting data based on arrangement information. More specifically, the control circuit 91 calculates a radius R of the cutting line of the hole 101 by adding a predetermined default value (0.4 mm, for example) to the value of a radius r of the rhinestone 100. The control circuit 91 then sets the cutting start and end points A₀ and Aₙ to a point (an uppermost point in FIG. 7B) where the Y coordinate becomes minimum on the circumference of a circle having as a center point O1 the coordinate value of each arrangement position and a radius R. The coordinate values of the cutting line data is calculated by dividing the circumference of the circle with the radius R at predetermined intervals regarding the apexes A₁, A₂, A₃ and so on including the cutting start point A₀. Thus, the coordinate values of the cutting line data are set for every center point O1 regarding the eight holes 101 and the delimiter data is added to the end of each cutting line data, whereby the cutting data for arranging the rhinestones 100 is generated.

The printing data will be described in detail with an example in which a red identification mark Mr, a blue identification mark Mb and a green identification mark Mg are to be printed on the object 6 based on the arrangement information. More specifically, eight cross-shaped identification marks Mr, Mb and Mg indicative of the color types of the rhinestones 100 are to be printed, as shown in FIG. 12C. The printing data in this case includes printing line data, color information “1” and “2”, delimiter data and displaying data.

The red identification mark Mr is printed at the peripheral edge of the hole 101 and is composed of four line segments L1 to L4 extending from the center point O1 into a cross shape, as shown in FIGS. 12A and 12D. The printing line data includes data of four line segments corresponding to the line segments L1 to L4. Each line segment data has coordinate data indicative of start points and end points of the corresponding line segments L1 to L4 in the form of X-Y coordinate. Printing line data of the other identification marks Mb and Mg also have coordinate data indicative of start points and end points of the corresponding line segments L1 to L4 in the form of X-Y coordinate. The printing line data of the identification marks Mr, Mb and Mg is stored in association with color data “0,” “1” and “2.”

In the example, the display 9a is controlled to display the cartridge 4p of the corresponding type of pen P based on the color information “0” to “2” in the case of printing. While viewing the screen of the display 9a, the user attaches the corresponding cartridge 4p to the cartridge holder 32. The control circuit 91 serving as the printing control unit executes the aforesaid printing operation to relatively move the pen P based on the printing line data so that four line segments L1 to L4 are plotted on the object 6, thereby printing the identification marks Mr to Mg for every color. Delimiter data is added to the end of each line segment data. The pen tip P1 is departed from the object 6 on the basis of the delimiter data every time the control circuit 91 finishes the plotting of each one of the line segments L1 to L4.

The control circuit 91 generates the above-described printing data based on the arrangement information. The control circuit 91 is configured as a grouping unit which groups the arrangement information for every color as will be described in detail in the description of the operation of the cutting apparatus 1. The control circuit 91 generates printing data for printing three identification marks Mr collectively with the red pen P. Furthermore, the control circuit 91 also generates printing data for printing the other identification marks Mb or Mg collectively with the blue or green pen P.

In this case, the control circuit 91 determines coordinate values of start points and end points of two line segments L1 and L3 both extending in the Y direction and coordinate values of start points and end points of two line segments L2 and L4 both extending in the X direction according to the coordinate vale of the center point O1 of the arrangement position or size information. As a result, the coordinate values are set so that the identification marks Mr, Mb and Mg are printed at positions on the peripheral edges of the holes 101. Thus, the coordinate values of printing line data are determined relative to the center points O1, and delimiter data is added to ends of line segment data. The control circuit 91 then associates the line segment data with color information “0” to “2” thereby to generate printing data of identification marks Mr, Mb and Mg indicative of the color types of rhinestones 100.

The RAM 93 has storage areas for temporarily storing the above-mentioned various programs, the cutting data and the printing data, set values entered by operation of the operation switches of the operation device 9b and the results of calculation carried out by the control circuit 91, and the like. In more detail, the RAM 93 is provided with a plurality of storage areas including a program storage area 931, a set value storage area 932, an arrangement information storage area 933, a change information storage area 934, a flag data storage area 935, an image display data storage area 936, a printing data storage area 937 and a cutting data storage area 938. The program storage area 931 stores various programs read from the ROM 92 and the like. The set value storage area 932 stores set values and tables referred to in execution of programs. The arrangement information storage area 933 stores arrangement information set by the user. The change information storage area 934 stores arrangement information grouped for every color. The flag data storage area 935 stores various flags used in execution of programs. The image display data storage area 936 stores image data of screens displayed by the display 9a and display settings. The printing data storage area 937 and the cutting data storage area 938 store printing data and cutting data respectively.

The control circuit 91, storage units such as the ROM 92 and RAM 93, the display 9a, the operation device 9b and the like in the above-described cutting apparatus 1 constitute a cutting data generator 90 (see FIG. 6), and the control circuit 91 and the display 9a constitute an informing unit.

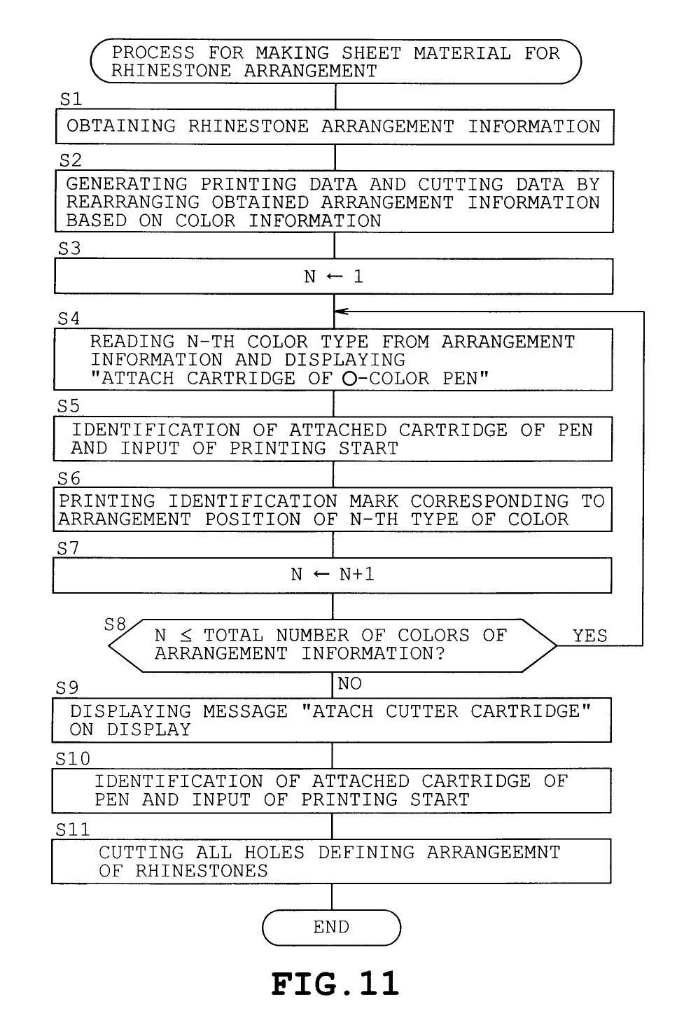

The operation of the cutting apparatus 1 thus configured will be described with reference to FIGS. 11 to 13. FIG. 11 is a flowchart showing a sequence of processes executed by the control circuit 91 on the cutting data generating program, a printing process and a cutting process. The following will exemplify a case where a sheet material defining arrangement of a plurality of types of rhinestones 100 (red, blue and green as described above, for example) using the cutting apparatus 1. The user prepares cartridges 4p of pens P of red, blue and green and the cartridge 4c of the cutter C. The sheet material is made using a plastic sheet applied to the holding sheet 10 as shown in FIG. 1.

The user firstly sets the holding sheet 10 holding the object 6 on the platen 3 of the cutting apparatus 1. In this case, when detecting insertion of the holding sheet 10 by the sheet detection sensor 96, the control circuit 91 sets as origin O the left side corner of the adhesive layer 10v in the holding sheet 10. Furthermore, the user operates the operation device 9b to display a menu screen (not shown) on the display 9a and instructs “making sheet material for rhinestone arrangement” in the menu screen. As a result, the processing of the cutting data generation program then starts.

In this case, the control circuit 91 displays an arrangement input screen (not shown) to input arrangement information of rhinestones 100 on the display 9a. The user then operates the device 9b to input arrangement positions of rhinestones 100, color information and size information (step S1). In this case, the rhinestones 100 may be arranged into a linear shape or a curved shape or into a matrix as shown in FIG. 8. Furthermore, the rhinestones 100 may be set to desirable colors such as red, green and blue, and the sizes of the rhinestones 100 may be set. In this case, circular marks Re, Gr and Bl may be displayed on the arrangement input screen as shown in FIG. 8. Still furthermore, coordinate values may be input directly or with a mouse or the like as will be described later, regarding arrangement positions of the respective rhinestones 100.

The arrangement information input at step S1 is stored in the RAM 93 with an input sequence serving as an arrangement order. More specifically, assume that the arrangement of a first row of rhinestones 100 is input sequentially from the left rhinestone 100 and subsequently, the arrangement of a second row of rhinestones 100 is input sequentially from the left rhinestone 100. Arrangement information in this case is written from the beginning of the arrangement information storage area 933 of the RAM 93 in the order of “0” to “7” of the ordinal data in FIG. 9A.

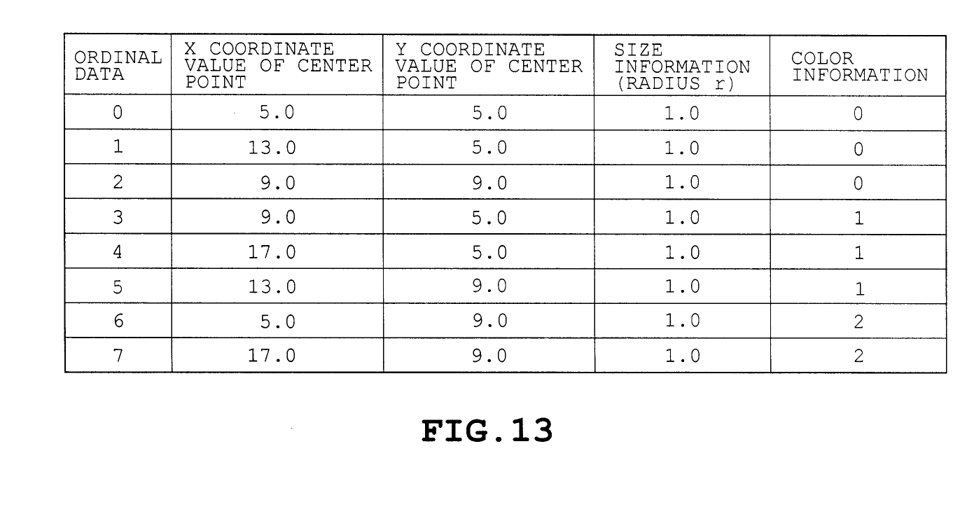

The arrangement order based on the arrangement information obtained as described above is changed by execution of grouping rhinestones 100 for every color (step S2). More specifically, the control circuit 91 collates the arrangement information obtained at step S1 to extract arrangement information with color information of “0,” that is, arrangement information of three circular marks designated by “Re” in FIG. 8. The arrangement information of three circular marks is indicative of a group of “red” with color information of “0” (see FIGS. 9A and 9B) and is stored collectively in the ordinal data of “0” to “2” from the beginning of the storage area 934, as shown in FIG. 13. In the same manner, the control circuit 91 collates original arrangement information in the arrangement information storage area 933 to extract arrangement information with color information of “1.” The extracted arrangement information is stored collectively as a group of “blue” in the order of ordinal data of “3” to “5” as shown in FIG. 13. Furthermore, the control circuit 91 extracts arrangement information with color information of “2” in the original arrangement information. The extracted arrangement information is stored collectively as a group of “green” in the order of ordinal data of “6” and “7” as shown in FIG. 13.

At step S2, the control circuit 91 further generates printing data based on arrangement information in the change information storage area 934. Based on the printing data, three identification marks Mr of red, three identification marks Mb of blue and two identification marks Mg of green are printed in this order. More specifically, the control circuit 91 calculates coordinate values of printing line data corresponding to the center lines O1 of the respective arrangement positions regarding eight identification marks Mr to Mg, generating printing data for every color according to ordinal data in FIG. 13. On the other hand, the control circuit 91 generates cutting data for cutting eight holes 101 based on the arrangement information in the arrangement information storage area 933. In this case, the control circuit 91 calculates radius R of the hole 101 from the radius r of the rhinestone 100 and the default value regarding each of eight holes 101. The control circuit 91 further calculates coordinate values of the cutting line data according to the arrangement positions to generate cutting data for cutting according to the ordinal data of FIG. 9A.

Subsequently, a printing process based on the generated printing data based on the generated printing data (steps S3 to S8) and a cutting process based on the generated cutting data (steps S9 to S11) are sequentially executed. Firstly, in the printing process, the control circuit 91 sets a counter N to “1” (step S3). The counter N is provided for counting the color number. The control circuit 91 collates the color information “0” and the specified color table (see FIGS. 13 and 9B) thereby to display the message, “Attach cartridge of red pen” on the display 9a (step S4).

The user then attaches the cartridge 4p of the red pen P to the cartridge holder 32 and switches the lever member 60 from the open position to the fixed position to fixed the cartridge 4p (see FIG. 4). The control circuit 91 detects presence or absence of movement of three contacts 82A to 82C by three type detection sensors 83A to 83C, identifying the type of the cartridge 4 (step S5). As a result, when identifying the cartridge 4p of red pen P, the control circuit 91 executes a printing operation when receiving the instruction of print start by operation of the operation device 9b (step S6).

In this case, the control circuit 91 relatively moves the red pen P based on the printing data to print three identification marks Mr (see FIG. 12A) in the order of “0” to “2.” The identification marks Mr correspond to the arrangement position (coordinate values) of the ordinal data “0” to “2” in FIG. 13. When the printing of the identification mark Mr of the first red is finished, the control circuit 91 increments the counter N to N+1 (step S7), returning to step S4 to print identification marks Mb and Mg of second and further colors (YES at step S8).

Regarding printing of second color, the control circuit 91 collates color information “1” of printing data and specified color table thereby to display a message facilitating attachment of the cartridge 4p of the blue pen P (step S4). When the user attaches and fixes the cartridge 4p of the blue pen P to the cartridge holder 32, instead of the cartridge 4p of the red pen P, the control circuit 91 identifies the type of the cartridge 4 based on detection signals of the type detection sensors 83A, 83B and 83C (step S5). As a result, when the cartridge 4p of the blue pen P is identified and print start is instructed, the control circuit 91 executes a printing operation with the blue pen P (step S6). In this case, three identification marks Mb corresponding to arrangement positions of “3” to “5” are printed with the blue pen P in the order of “3”, “4” and “5” (see FIG. 12B). When the printing of the identification marks Mb of the second blue, the control circuit 91 increments the counter N by 1 (step S7), returning to step S4 (YES at step S8).

Furthermore, regarding printing of the third color, the control circuit 91 collates color information “2” of the printing data and the specified color table thereby to display a message facilitating attachment of the cartridge 4p of the green pen P (step S4). When the user attaches and fixes the cartridge 4p of the green pen P to the cartridge holder 32, instead of the cartridge 4p of the blue pen P, the control circuit 91 identifies the type of the cartridge 4 based on detection signals of the type detection sensors 83A, 83B and 83C (step S5). As a result, when the cartridge 4p of the green pen P is identified and print start is instructed, the control circuit 91 executes a printing operation with the green pen P (step S6). In this case, three identification marks Mg corresponding to arrangement positions of “6” and “7” are printed with the green pen P in the order of “6” and “7” (see FIG. 12C). When the printing of the identification marks Mg of the third green, the control circuit 91 increments the counter N by 1 (step S7), determining whether or not the value of the counter N is 3 as the number of types of all pieces of color information “0” to “2” or smaller than 3. In this case, since the value of N is 4 exceeding the number of all pieces of color information “0” to “2,” the control circuit 91 determines in the negative at step S8.

After all the identification marks Mr, Mb and Mg have been printed, the control circuit 91 causes the display 9a to display the message, “Attach cutter cartridge” (step S9). The user then attaches and fixes the cartridge 4c of the cutter C to the cartridge holder 32, instead of the cartridge 4p of the green pen P. In this case, the control circuit 91 identifies the type of the cartridge 4 based on the detection signals of the type detection sensors 83A to 83C (step S10). The control circuit 91 stands by for instructions to start cutting by the operation of the operation device 9b when having identified the cartridge 4c of the cutter C. The control circuit 91 executes the cutting operation upon receipt of the instructions (step S11). The control circuit 91 causes the cutter C to relatively move based on the cutting data, so that eight holes 101 corresponding to the arrangement positions are formed on the object 6 in the order of ordinal data “0” to “7” in FIG. 9A (see FIG. 12D). When the cutting of all the holes 101 has been finished, the control circuit 91 ends the sequence of processing regarding the printing and cutting.

Upon end of the processing, the user can use the object 6 removed from holding sheet 10 as a sheet material for arrangement of rhinestones 100. On the sheet material are printed all the identification marks Mr, Mb and Mg which correspond to the respective red, blue and green colors of the rhinestones 100 required for decoration and are located on peripheral edges of the respective holes 101, as shown in FIG. 12D. Accordingly, the identification marks Mr, Mb and Mg on the sheet material can represent an overall coloration image of rhinestones 100. Furthermore, the rhinestones 100 can easily be fitted into the respective holes 100 without error in color. The rhinestones 100 are bonded to clothes by heat generated by an iron (not shown), for example.

The cutting apparatus 1 of the example includes the printing control unit which controls the printing instrument to print on the object 6 (the sheet material) the identification marks corresponding to the respective arrangement positions of the rhinestones 100 and representing the respective types of the rhinestones 100, based on arrangement information obtained by the arrangement position obtaining unit. The cutting apparatus also includes the cutting control unit which controls the cutting instrument to cut the sheet material according to the arrangement positions of the plural holes 101 for arranging the rhinestones 100.

According to the above-described configuration, a plurality of holes 101 for arranging the rhinestones 100 can be cut in the sheet material by the cutting instrument and the identification marks Mr, Mb and Mg indicative of the respective color types of the rhinestones 100 can be printed on the sheet material. Consequently, the colors of the rhinestones arranged in the respective holes of the sheet material can be identified by the identification marks Mr, Mb and Mg, with the result that a plurality of types of rhinestones having different colors can be arranged easily and accurately.

The cutting apparatus 1 includes the grouping unit which groups for every color the arrangement information obtained by the arrangement information obtaining unit. The printing instrument is configured to selectively sue a plurality of types of pens P having different colors. The printing control unit executes control to print the identification marks Mr, Mb and Mg for every color with the pens corresponding to the color types of the rhinestones 100, based on the grouped arrangement information. According to this configuration, since the arrangement information is grouped for every color, the printing control unit can execute control so that the number of times of replacement of the pens P can be suppressed to requisite minimum, based on the grouped arrangement information. This control manner can shorten a time period required for printing the identification marks Mr, Mb ad Mg, with the result that the printing can be carried out efficiently.

The cutting apparatus 1 is configured so that the cartridge 4p of the pen P used as the printing instrument or the cartridge 4c of the cutter C used as the cutting instrument are detachably attachable thereto. The cutting apparatus 1 includes the informing unit which informs of the pen cartridge 4p or the cutter cartridge 4c to be detached or attached in the printing or the cutting. According to the above-described configuration, the user can obtain information about the type of the cartridge 4p or 4c in execution of the printing or the cutting, with the result that the cartridge 4 can reliably be replaced.

The cutting control unit controls the cutting instrument to cut the plural holes 101 after the identification marks Mr, Mb and Mg have been printed. If the identification marks Mr, Mb and Mg are printed after the holes 101 have been cut in the sheet material, there is a possibility that a cutting mark (a cutting line) would sometimes disturb the printed identification marks Mr, Mb and Mg. In the embodiment, however, clear identification marks can be printed since the holes 101 are cut after the identification marks Mr, Mb and Mg have been printed.

The printing control unit controls the printing instrument to print the identification marks Mr, Mb and Mg at positions on the peripheral edges of the holes 101. According to this control manner, the correspondence relationship between holes 101 and the identification marks Mr, Mb and Mg is rendered understandable, with the result that the rhinestones 100 having different colors can be arranged correctly. Furthermore, the entire coloration image can be represented more correctly by the identification marks Mr, Mb and Mg on the sheet material before arrangement of the rhinestones 100.

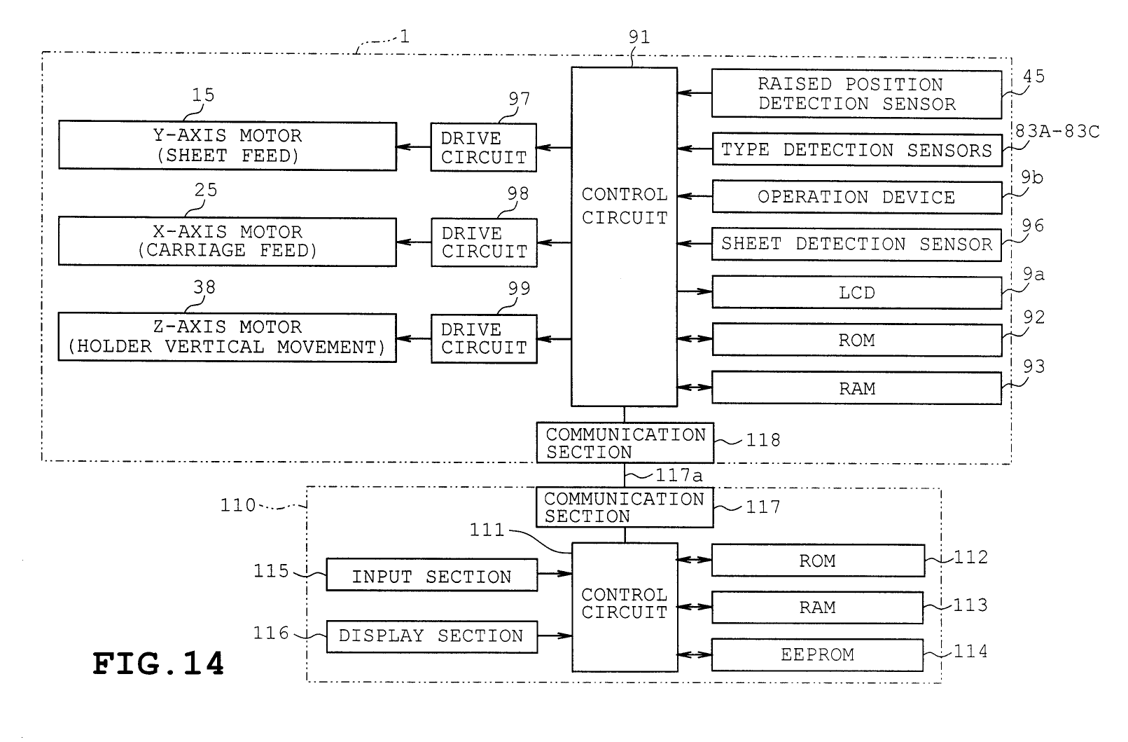

FIG. 14 illustrates a second embodiment. Only the differences between the first and second embodiments will be described. Identical or similar parts in the second embodiment will be labeled by the same reference symbols as those in the first embodiment.

A personal computer (hereinafter, “PC 110”) as shown in FIG. 14 is configured as a cutting data generator which generates the above-described printing data and the cutting data. More specifically, the PC 110 includes a control circuit 111 which is a control device mainly composed of the computer (CPU). A ROM 112, a RAM 113 and an EEPROM 114 are connected to the control circuit 111. An input section 115 is also connected to the control circuit 111 and includes a key board, a mouse and the like for the user to operate for various instructions, selection and input. A display section 116 (LCD, for example) is further provided for displaying necessary massage or the like to the user. The PC 110, the display section 116, the keyboard and mouse serve as am arrangement information obtaining unit. For example, the PC 110 obtains as an arrangement position corresponding to the X-Y coordinate system of the cutting apparatus 1 position coordinates of the mouse on the LCD designated by the operation of the mouse.

The PC 110 includes a communication section 117 which performs wired connection or wireless connection to the cutting apparatus 1. The communication section 117 is connected via a cable 117a to a communication section 118 of the cutting apparatus 1, for example. As a result, transmission/reception of data including the cutting data is executable between the PC 110 and the cutting apparatus 1. The control circuit 111 controls the entire PC 110 and executes the above-described cutting data generating program and the like. The ROM 112 stores the cutting data generating program, an operation information table and the like. The RAM 113 temporarily stores data and programs necessary for various processes and has the same storage areas as the arrangement information storage area 933, the change information storage area 934, the printing data storage area 937 and the cutting data storage area 938. The EEPROM 114 stores various cutting data.

The control circuit 111 executes processes of the cutting data generation program, that is, steps S1 and S2 in FIG. 11. As a result, the control circuit 111 generates printing data and cutting data, based on arrangement information in the same manner as in the first embodiment. The printing data is used to print the identification marks Mr, Mb and Mg so that the identification marks Mr, Mb and Mg correspond to the arrangement positions of the rhinestones 100. The cutting data is used to cut a plurality of holes 101 for arranging the rhinestones 100 on the sheet material. The generated printing data and cutting data are stored in the printing data storage area and the cutting data storage area of the RAM 113 respectively.

The control circuit 111 is configured as the arrangement information obtaining unit, the grouping unit, the printing data generating unit and the cutting data generating unit as in the first embodiment. Accordingly, the printing data and the cutting data can be generated on the PC 110, so that the control circuit 111 can achieve the same advantage effects as the cutting data generator 90 in the first embodiment. Consequently, the sheet material defining the arrangement of the rhinestones 100 can be made when the generated printing data and cutting data are read by the computer of the apparatus 1 having the printing instrument and the cutting instrument or a printing device and a cutting device and printing processes and cutting processes are executed.

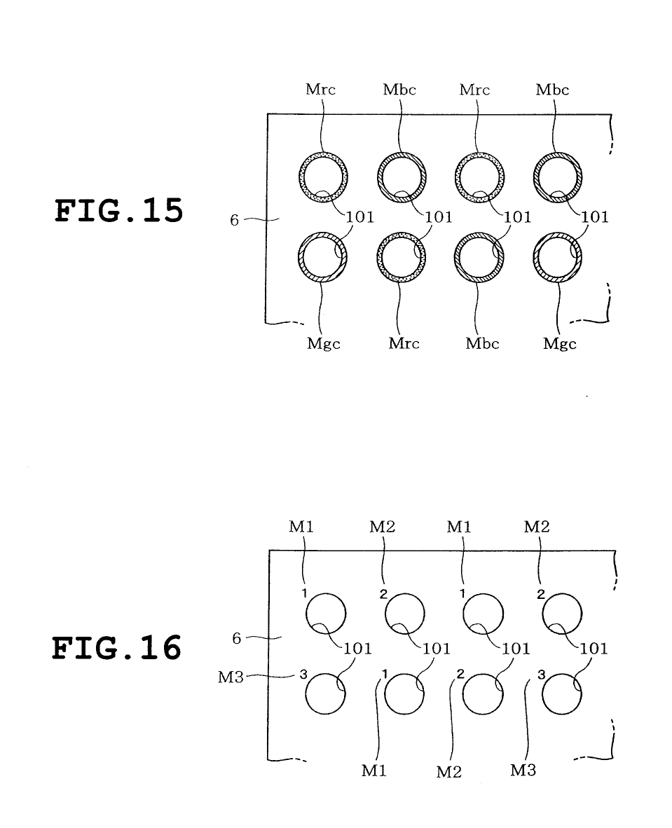

FIGS. 15 and 16 illustrate a third embodiment and a fourth embodiment respectively. Identical or similar parts in the third end further embodiments are labeled by the same reference symbols as those in the first embodiment and the description of these identical parts will be eliminated. Only the differences will be described.

The identification marks Mrc, Mbc and Mgc in the third embodiment are each formed into a circular shape along the peripheral edge of the hole 101 as shown in FIG. 15. The identification marks Mrc, Mbc and Mgc are printed using the cartridges 4p of the pens P of red, blue and green colors corresponding to the identification marks Mr, Mb and Mg in the first embodiment. Accordingly, the printing line data can be generated by calculating radii of the identification marks Mrc, Mbc and Mgc from the radius r of the rhinestone 100 and the defaults and calculating coordinate values of the positions printed according to the arrangement positions, in the same manner as the cutting line data.

Identification marks M1, M2 and M3 in the fourth embodiment as shown in FIG. 16 are numerals located on the immediately rear left sides of the holes 101 (upper left sides of the holes on the drawing sheet of FIG. 16). The numerals are printed by the cartridges 4p of pens P of the colors differing from one another (colors of red, blue and green, for example). The identification marks may be printed by the cartridge 4p of the pen P of a single color (black, for example) instead of the different colors. Arrangement of the rhinestones 100 of different colors can be specified by the numerals “1,” “2” and “3” of the identification marks M1 to M3. The printing data is usable to print the numerals “1,” “2” and “3” corresponding to the color information “0” to “2.” The printing data is generated by obtaining coordinate values of the aforesaid rear left sides (upper left sides) serving as printing positions from coordinate values of the arrangement positions of the rhinestones 100, radii r and defaults.

The identification marks Mrc, Mbc and Mgc may only be lines located at the peripheral edges of the holes and represented by the colors of the rhinestones 100. Furthermore, the identification marks M1 to M3 in the fourth embodiment should not be limited to numerals but may be characters of “red,” “blue” and “green” or any symbols which can identify the colors of the rhinestones 100. According to the identification marks Mrc, Mbc and Mgc or M1 to M3, the user can identify the colors of the rhinestones 100 to be arranged in the respective holes, and thus, the third embodiment can achieve the same advantageous effect as those in the first embodiment.

The foregoing embodiments should not be restrictive but may be changed or expanded as follows. The printing data and the cutting data should not be limited to the rhinestones 100 but may be generated with respect to the sheet material defining arrangement of various types of granular decorative pieces. Regarding the types of the decorative pieces, the size, the shape and the like may be caused to differ other than the colors.

The invention should not be limited to the cutting apparatus 1 as the above-described cutting plotter but may be applied to various apparatuses each provided with the printing instrument and a cutting instrument. A plurality of holes and identification marks may be applied to the sheet material defining the arrangement of the decorative pieces using a cutting apparatus having a printing device having a printing instrument and a cutting apparatus having a cutting instrument.

The printing instrument may be configured by in ink jet system or an electronic photography system using toner, instead of the system of a pen plotter using the cartridge 4p of the pen P. Also, the cutting instrument may be configured using various types of cutting instruments provided with respective cutting blades, instead of the cartridge 4p of the cutter C. The arrangement information obtaining unit may obtain arrangement information by various operation switches of the operation device 9b, the mouse or a touch panel. Furthermore, the arrangement information obtaining unit may obtain arrangement information by wireless communication using the communication sections 117 and 118, or the like. Furthermore, the printing processes as shown in steps S3 to S8 as shown in FIG. 11 may be executed after execution of the cutting processes at steps S9 to S11.

Instructions by the cutting data generation program should not be limited to those stored in a storage unit in the cutting apparatus 1 or the PC110 but may be stored by a non-transitory computer-readable medium (a storage medium) a USB memory, a CD-ROM, a flexible disc, a DVD a flash memory and the like. In this case, when the data stored in the storage medium is read by a computer of each one of the data processing devices to be executed, the same operation and advantageous effects as those in the foregoing embodiments can be achieved.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting data generator comprising:
a control device configured to:
obtain arrangement information including arrangement positions for arranging a plurality of types of decorative pieces with at least different colors and said plurality of the types of the decorative pieces;
generate print data for printing identification marks at respective positions, based on the obtained arrangement information, the positions where the identification marks are to be printed corresponding to the arrangement positions respectively, the identification marks being indicative of the types of the decorative pieces respectively; and
generate cutting data for cutting a plurality of holes in a sheet material, based on the obtained arrangement information, the holes being usable to arrange the decorative pieces on the sheet material.

2. The cutting data generator according to claim 1, wherein the control device is configured to generate print data to be usable to print the identification marks at positions on peripheral edges of the holes respectively.

3. The cutting data generator according to claim 2, wherein each identification mark is at least any one of a character, a number, a symbol or a line each one of which is capable of identifying the color of the decorative piece, the line being located at the periphery of each hole and is indicative of the color of each decorative piece.

4. A non-transitory computer-readable storage medium storing computer-readable instructions that, when executed by a processor, cause the processor to perform the steps of:
obtaining arrangement information including arrangement positions for arranging a plurality of types of decorative pieces with at least different colors and said plurality of the types of the decorative pieces;
generating print data for printing identification marks at respective positions, based on the obtained arrangement information, the positions where the identification marks are to be printed corresponding to the arrangement positions respectively, the identification marks being indicative of the types of the decorative pieces respectively; and
generating cutting data for cutting a plurality of holes in a sheet material, based on the obtained arrangement information, the holes being usable to arrange the decorative pieces on the sheet material.

5. The storage medium according to claim 4, wherein the steps further include a step of printing the identification marks at positions on peripheral edges of the holes respectively.

6. The storage medium according to claim 5, wherein each identification mark is at least anyone of a character, a number, a symbol or a line each one of which is capable of identifying the color of the decorative piece, the line being located at the periphery of each hole and is indicative of the color of each decorative piece.

7. A cutting apparatus comprising:
a printing instrument configured to print on a sheet material;
a cutting instrument configured to cut the sheet material; and
a control device configured to:
obtain arrangement information including arrangement positions for arranging a plurality of types of decorative pieces with at least different colors and said plurality of the types of the decorative pieces;
control the printing instrument so that identification marks are printed at respective positions, based on the obtained arrangement information, the positions where the identification marks are to be printed corresponding to the arrangement positions respectively, the identification marks being indicative of the types of the decorative pieces respectively; and
control the cutting instrument so that a plurality of holes is cut in a sheet material, based on the obtained arrangement information, the holes being usable to arrange the decorative pieces on the sheet material.

8. The cutting apparatus according to claim 7, wherein:
the printing instrument includes a plurality of types of pens with different colors, selectively used;
the control device is configured to group the obtained arrangement information for every color;
the control device is configured to execute control to print the identification mark for every color based on the grouped arrangement information, the identification mark for every color being printed using the pen corresponding to the type of color of the decorative piece.

9. The cutting apparatus according to claim 7, further comprising an informing device configured to inform in printing or cutting, the cutting apparatus being configured so that a cartridge of a pen used as the printing instrument or a cartridge of a cutting blade used as the cutting instrument is detachably attachable thereto, wherein the informing instrument is configured to inform of either the pen cartridge or the cutting blade cartridge.

10. The cutting apparatus according to claim 7, wherein the control device is configured to control the cutting instrument so that the holes are cut after the identification marks have been printed.

11. The cutting apparatus according to claim 7, wherein the control device is configured to control the printing instrument so that the identification marks are printed at positions on peripheral edges of the holes respectively.

12. The cutting apparatus according to claim 7, wherein each identification mark is at least any one of a character, a number, a symbol or a line each one of which is capable of identifying the color of the decorative piece, the line being located at the periphery of each hole and is indicative of the color of each decorative piece.
